(19) United States
(12) Patent Application Publication
(10) Pub. No.: US 2025/0201491 A1
(43) Pub. Date: Jun. 19, 2025

(54) NEGATIVE ELECTRODE MATERIAL FOR ZINC-ION CAPACITOR, MANUFACTURING METHOD THEREFOR, AND ZINC-ION CAPACITOR

(71) Applicant: Industry-Academic Cooperation Foundation Gyeongsang National University, Jinju-si (KR)

(72) Inventors: Geon Hyoung An, Junju-si (KR); Ki Hyuk Yun, Seoul (KR)

(21) Appl. No.: 18/836,685

(22) PCT Filed: Jan. 16, 2023
(86) PCT No.: PCT/KR2023/000718

§ 371 Date: Aug. 7, 2024

(30) Foreign Application Priority Data
Mar. 29, 2022 (KR) 10-2022-0038813

(51) Int. Cl. H01G 11/28; H01G 11/30; H01G 11/86

(52) U.S. Cl. CPC H01G 11/28; H01G 11/30; H01G 11/86

(57) ABSTRACT

The present invention relates to a negative electrode material for a zinc-ion capacitor, a manufacturing method therefor, and a zinc-ion capacitor. The negative electrode material for a zinc-ion capacitor, according to an embodiment of the present invention, comprises embossed and punched zinc (Zn), wherein the embossed zinc has a plurality of irregularities having a cross-section in a convex shape, a concave shape, or both the shapes, and the punched zinc has macropores formed therein.

### TECHNICAL FIELD

The present discloser relates to a negative electrode material for a zinc-ion capacitor, a manufacturing method therefor, and a zinc-ion capacitor.

### BACKGROUND ART

Zinc-ion supercapacitors (ZICs) using zinc (Zn) electrodes among multivalent cations exhibits high capacitance and −0.76 V (low redox potential compared to standard hydrogen) induced by a Faradaic redox reaction due to deposition and stripping of Zn²⁺.

In addition, zinc metals exhibit long cycling stability due to their excellent overvoltage stability in response to a generation of hydrogen, in comparison to other metal electrodes used in water-based electrochemical systems, and are inexpensive, safe, and environmentally friendly.

However, when a plane-shaped zinc metal electrode was used, disadvantages of low energy storage performance during charging and discharging at the high speed due to a low diffusion capability of zinc ions were obtained.

There is a need to develop a negative electrode material that may improve rate performance and cycling stability of a zinc-ion battery (ZIB).

### DISCLOSURE OF THE INVENTION

### Technical Goals

To solve the above-described problems, the present disclosure is to provide a negative electrode material for a zinc-ion capacitor, a method of manufacturing the same, and a zinc-ion capacitor that may improve rate performance and cycling stability by increasing a surface area and enhancing an ion diffusion capability, and a wettability.

However, goals to be achieved are not limited to those described above, and other goals not mentioned above can be clearly understood by one of ordinary skill in the art from the following description.

### Technical Solutions

A negative electrode material for a zinc-ion capacitor according to an embodiment of the present disclosure includes embossed and punched zinc (Zn), wherein the embossed zinc includes a plurality of irregularities having cross sections with a convex shape, a concave shape, or both the shapes, and the punched zinc includes macropores formed therein.

In an embodiment, the embossed zinc may have a pattern with at least one shape selected from a group consisting of a triangle, a square, a pentagon, a hexagon, an octagon, a sphere, a hemisphere, a circle, and an oval.

In an embodiment, the pattern may have a spacing of 30 μm to 200 μm, and a furrow with a depth of 100 μm to 600 μm.

In an embodiment, the macropores may have a width of 50 μm to 200 μm.

In an embodiment, a water contact angle on a surface of the negative electrode material for the zinc-ion capacitor may range from 50° to 100°.

A method of manufacturing a negative electrode material for a zinc-ion capacitor according to another embodiment of the present disclosure includes a step of preparing a zinc (Zn) foil; and a step of performing roll pressing such that a surface of the zinc (Zn) foil is embossed and punched, by disposing a metal mesh on the surface of the zinc (Zn) foil.

In an embodiment, the step of performing roll pressing may include passing the metal mesh on the zinc (Zn) foil between a first roller and a second roller, which face each other, performing roll pressing with the first roller and the second roller at a pressure of 100 psi to 2,000 psi, a temperature of 20° C. to 100° C., and a movement speed of 0.01 m/min to 1 m/min, and forming an embossed and punched structure on the zinc (Zn) foil.

In an embodiment, the metal mesh may have a pattern with at least one shape selected from a group consisting of steel use stainless (SUS), a vinyl-coated material (VCM) steel plate, galvanized steel material (hot-dipped galvanized iron (GI) sheet), an electronic galvanized iron (EGI) sheet, a hot-rolled, hot-dipped galvanized iron (HGI) sheet, a pre-coated metal (PCM) steel plate, and aluminum (Al).

In an embodiment, the metal mesh may have a pattern with at least one shape selected from a group consisting of a triangle, a square, a pentagon, a hexagon, an octagon, a sphere, a hemisphere, a circle, and an oval.

In an embodiment, the pattern of the metal mesh may have a spacing of 30 μm to 200 μm, and the metal mesh may have a thickness of 100 μm to 600 μm.

A zinc-ion capacitor according to another embodiment of the present disclosure includes the negative electrode material for the zinc-ion capacitor according to an embodiment of the present disclosure, or a negative electrode material for a zinc-ion capacitor manufactured by the method of manufacturing the negative electrode material for the zinc-ion capacitor according to another embodiment of the present disclosure; a positive electrode material including a carbon material; and an aqueous electrolyte filled between the negative electrode material and the positive electrode material.

In an embodiment, the carbon material may include at least one selected from a group consisting of activated carbon, acetylene black, furnace black, carbon black, Ketjen black, Super-P, graphene, and graphite.

In an embodiment, the aqueous electrolyte may include at least one selected from a group consisting of zinc sulfate (ZnSO₄), zinc chloride (ZnCl₂), zinc bromide (ZnBr₂), zinc acetate (Zn(O₂CCH₃)₂), and zinc nitrate (Zn(NO₃)₂) of 0.5 M to 3 M.

In an embodiment, the zinc-ion capacitor may have an energy density of 50 W h kg⁻¹ to 200 W h kg⁻¹ at 450 W kg⁻¹ to 9,000 W kg⁻¹.

In an embodiment, the zinc-ion capacitor may have a specific capacity of 70 mAh g⁻¹ to 150 mAh g⁻¹ at a current density of 10.0 A g⁻¹.

In an embodiment, the zinc-ion capacitor may have a capacitance retention of 90% or greater after “10,000” cycles at a current density of 10.0 A g⁻¹.

### Effects of the Invention

A negative electrode material for a zinc-ion capacitor according to an embodiment of the present disclosure may include an embossed and punched structure, to provide an efficient ion diffusion pathway, which may lead to enhanced rate performance. In addition, the negative electrode material for the zinc-ion capacitor may exhibit an excellent lifespan characteristic by showing an excellent capacitance retention and exhibit an excellent capacitance retention at a high charge and discharge rate.

By a method of manufacturing a negative electrode material for a zinc-ion capacitor according to an embodiment of the present disclosure, a negative electrode material for a zinc-ion capacitor, which has an embossed and punched surface structure with an enhanced ion diffusion capability and wettability, may be manufactured.

A zinc-ion capacitor according to an embodiment of the present disclosure may include a zinc-ion negative electrode material with a controlled surface structure, to enhance a diffusion capability of zinc-ions. Thus, an electrochemical reaction area may increase, to enhance energy storage performance and lifetime stability.

### BRIEF DESCRIPTION OF DRAWINGS

FIG. 1 is a diagram schematically illustrating a negative electrode material for a zinc-ion capacitor according to an embodiment of the present disclosure.

FIG. 2 is a diagram schematically illustrating a method of manufacturing a negative electrode material for a zinc-ion capacitor according to an embodiment of the present disclosure.

FIG. 3 illustrates a morphological characterization of a zinc negative electrode material: FIGS. 3A to 3C illustrate photographic images with inset images obtained under illumination from below, FIGS. 3D to 3F illustrate low-magnification images, and FIGS. 3G to 3I illustrate high-magnification scanning electron microscopy (SEM) images of bare Zn (FIGS. 3A, 3D, and 3G), an embossed Zn negative electrode material (EZN; FIGS. 3B, 3E, and 3H), and an embossed and punched Zn negative electrode material (EPZN; FIGS. 3C, 3F, and 3I), according to an embodiment of the present disclosure.

FIGS. 4A, 4C, and 4E illustrate three-dimensional surface confocal laser III scanning microscopy (3D SCLSM) images and FIGS. 4B, 4D, and 4F illustrate corresponding height plots of a bare Zn electrode (FIGS. 4A and 4B), an EZN electrode (FIGS. 4C and 4D), and an EPZN electrode (FIGS. 4E and 4F), according to an embodiment of the present disclosure.

FIGS. SA to 5C illustrate a structural characterization of a Zn negative electrode material via an X-ray diffraction (XRD) (FIG. 5A), Zn 2p X-ray photoelectron spectroscopy (XPS) (FIG. 5B), and a measurement of a porosimetry (FIG. 5C), and FIGS. 5D to 5F illustrate measurements of contact angles of a bare Zn electrode (FIG. 5D), an EZN electrode (FIG. 5E), and an EPZN electrode (FIG. 5F), according to an embodiment of the present disclosure.

FIG. 6 illustrates results of an electrochemical kinetics analysis of a bare Zn electrode, an EZN electrode, and an EPZN electrode, according to an embodiment of the present disclosure.

FIG. 7 illustrates electrochemical performance results of a ZIC fabricated using a bare Zn electrode, an EZN electrode, and an EPZN electrode, according to an embodiment of the present disclosure.

FIG. 8 illustrates SEM images of a bare Zn electrode (FIGS. 8A, 8D, and 8G), an EZN electrode (FIGS. 8B, 8E, and 8H), and an EPZN electrode (FIGS. 8C, 8F, and 8I) obtained after a charging process at a high current density of 10.0 A g⁻¹, according to an embodiment of the present disclosure.

FIG. 9A illustrates cyclic stabilities of a bare Zn electrode, an EZN electrode, and an EPZN electrode for up to “10,000” cycles at a high current density of 10.0 A g⁻¹, and FIGS. 9B to 9G illustrate SEM images of the bare Zn electrode (FIGS. 9B and 9E), the EZN electrode (FIGS. 9C and 9F), and the EPZN electrode (FIGS. 9D and 9G) after a cycling test at the high current density of 10.0 A g⁻¹, according to an embodiment of the present disclosure.

FIG. 10 is a diagram schematically illustrating advantages of an EPZN electrode, including an improved ion diffusion capability and stable Zn plating, along with an enhanced electrode, according to an embodiment of the present disclosure.

### BEST MODE FOR CARRYING OUT THE INVENTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Furthermore, the terms first, second, A, B, and the like, may be used to describe components of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and duplicated descriptions will be omitted.

A negative electrode material for a zinc-ion capacitor according to an embodiment of the present disclosure may include embossed and punched zinc (Zn), the embossed zinc may include a plurality of irregularities having cross sections with a convex shape, a concave shape, or both the shapes, and the punched zinc may include macropores formed therein.

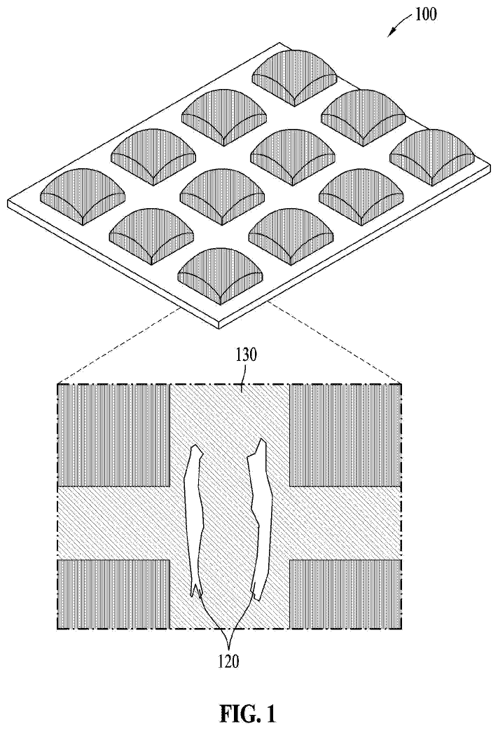

FIG. 1 is a diagram schematically illustrating a negative electrode material for a zinc-ion capacitor according to an embodiment of the present disclosure.

Referring to FIG. 1, a negative electrode material 100 for a zinc-ion capacitor according to an embodiment of the present disclosure includes embossed zinc 110, punched zinc 120, and farrows 130.

In an embodiment, the embossed zinc may have a pattern with at least one shape selected from a group consisting of a triangle, a square, a pentagon, a hexagon, an octagon, a sphere, a hemisphere, a circle, and an oval. Even when the pattern has a rectangular shape, a portion of the pattern may have a curve.

Desirably, the embossed zinc may have a square shape.

In an embodiment, the pattern may have a spacing of 30 μm to 200 μm; 30 μm to 150 μm; 30 μm to 100 μm; 30 μm to 50 μm; 50 μm to 200 μm; 50 μm to 150 μm; 50 μm to 100 μm; 80 μm to 200 μm; 80 μm to 150 μm; 80 μm to 100 μm; 100 μm to 200 μm; or 100 μm to 150 μm.

In an embodiment, the pattern may have a furrow with a depth of 100 μm to 600 μm; 100 μm to 500 μm; 100 μm to 400 μm; 100 μm to 300 μm; 100 μm to 200 μm; 100 μm to 200 μm; 200 μm to 600 μm; 200 μm to 500 μm; 200 μm to 400 μm; 200 μm to 300 μm; 300 μm to 600 μm; 300 μm to 500 μm; 300 μm to 400 μm; 400 μm to 600 μm; 400 μm to 500 μm; or 500 μm to 600 μm.

In an embodiment, the macropores may have a width of 50 μm to 200 μm; 50 μm to 150 μm; 50 μm to 100 μm; 80 μm to 200 μm; 80 μm to 150 μm; 80 μm to 100 μm; 100 μm to 200 μm; or 100 μm to 150 μm.

In an embodiment, an efficient ion-diffusion pathway may be provided as a spacing between the embossed zinc decreases, which may lead to enhanced rate performance of a zinc-ion capacitor including the negative electrode material for the zinc-ion capacitor.

An ion diffusion coefficient of a zinc-ion capacitor according to an embodiment of the present disclosure may range from 3.0×10⁻¹⁷ cm² s⁻¹ to 10.0×10⁻¹⁷ cm² s⁻¹.

In an embodiment, a water contact angle on a surface of the negative electrode material for the zinc-ion capacitor may range from 50° to 100°; 50° to 80°; 50° to 60°; 60° to 100°; 60° to 80°; 70° to 100°; 70° to 80°; 80° to 100°; or 90° to 100°.

The water contact angle on the surface of the negative electrode material for the zinc-ion capacitor according to an embodiment of the present disclosure is low in comparison to a flat and smooth surface of a zinc (Zn) foil, due to an embossed and punched structure. Accordingly, it can be found that a wettability is excellent. This may enhance rate performance and long cycling stability of the zinc-ion capacitor by an efficient operation of an electrode-electrolyte interface.

In an embodiment, the negative electrode material for the zinc-ion capacitor may include an embossed and punched structure, to provide an efficient ion diffusion pathway, which may lead to enhanced rate performance. In addition, the negative electrode material for the zinc-ion capacitor may exhibit an excellent lifespan characteristic by showing an excellent capacitance retention and exhibit an excellent capacitance retention at a high charge and discharge rate.

A method of manufacturing a negative electrode material for a zinc-ion capacitor according to another embodiment of the present disclosure includes a step of preparing a zinc (Zn) foil; and a step of performing roll pressing such that a surface of the zinc (Zn) foil is embossed and punched, by disposing a metal mesh on the surface of the zinc (Zn) foil.

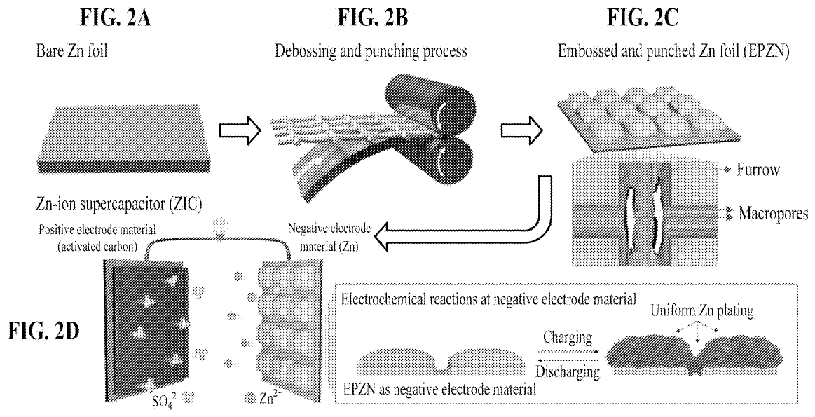

FIG. 2 is a diagram schematically illustrating a process of manufacturing a negative electrode material for a zinc-ion capacitor according to an embodiment of the present disclosure.

Referring to FIG. 2, the process of manufacturing the negative electrode material for the zinc-ion capacitor according to an embodiment of the present disclosure includes a step of preparing a zinc (Zn) foil (FIG. 2A), and a step of performing roll pressing (FIG. 2B).

As illustrated in FIG. 2A, in the step of preparing the zinc (Zn) foil, a zinc (Zn) foil of 10 μm to 50 μm is prepared.

As illustrated in FIG. 2B, the step of performing the roll pressing may include passing the metal mesh on the zinc (Zn) foil between a first roller and a second roller, which face each other, performing roll pressing with the first roller and the second roller at a pressure of 100 psi to 2,000 psi; 100 psi to 1,500 psi; 100 psi to 1,000 psi; 100 psi to 500 psi; 500 psi to 2,000 psi; 500 psi to 1,500 psi; 500 psi to 1,000 psi; 1,000 psi to 2,000 psi; or 1,000 psi to 1,500 psi, a temperature of 20° C. to 100° C.; 20° C. to 80° C.; 20° C. to 50° C.; 20° C. to 30° C.; 50° C. to 100° C.; 50° C. to 80° C.; or 80° C. to 100° C., and a movement speed of 0.01 m/min to 1 m/min; 0.01 m/min to 0.05 m/min; 0.01 m/min to 0.1 m/min; 0.05 m/min to 1 m/min; or 0.1 m/min to 0.05 m/min, and forming an embossed and punched structure on the zinc (Zn) foil.

When a pressure applied to the zinc (Zn) foil increases, a surface may have a debossed structure while having a punched structure.

In an embodiment, the metal mesh may have a pattern with at least one shape selected from a group consisting of steel use stainless (SUS), a vinyl-coated material (VCM) steel plate, galvanized steel material (hot-dipped galvanized iron (GI) sheet), an electronic galvanized iron (EGI) sheet, a hot-rolled, hot-dipped galvanized iron (HGI) sheet, a pre-coated metal (PCM) steel plate, and aluminum (AI).

Desirably, the metal mesh may be steel use stainless (SUS).

In an embodiment, the metal mesh may have a pattern with at least one shape selected from a group consisting of a triangle, a square, a pentagon, a hexagon, an octagon, a sphere, a hemisphere, a circle, and an oval.

Desirably, the metal mesh may have a square pattern.

In an embodiment, the pattern of the metal mesh may have a spacing of 30 μm to 200 μm; 30 μm to 150 μm; 30 μm to 100 μm; 30 μm to 50 μm; 50 μm to 200 μm; 50 μm to 150 μm; 50 μm to 100 μm; 80 μm to 200 μm; 80 μm to 150 μm; 80 μm to 100 μm; 100 μm to 200 μm; or 100 μm to 150 μm.

In an embodiment, the metal mesh may have a thickness of 100 μm to 600 μm; 100 μm to 500 μm; 100 μm to 400 μm; 100 μm to 300 μm; 100 μm to 200 μm; 100 μm to 200 μm; 200 μm to 600 μm; 200 μm to 500 μm; 200 μm to 400 μm; 200 μm to 300 μm; 300 μm to 600 μm; 300 μm to 500 μm; 300 μm to 400 μm; 400 μm to 600 μm; 400 μm to 500 μm; or 500 μm to 600 μm.

In an embodiment, as the spacing of the pattern of the metal mesh decreases, a clarity of the embossed structure may increase. Accordingly, an efficient ion diffusion pathway may be provided, which may lead to enhanced rate performance of a zinc-ion capacitor including the negative electrode material for the zinc-ion capacitor.

A negative electrode material for a zinc-ion capacitor manufactured by a method of manufacturing a negative electrode material for a zinc-ion capacitor according to an embodiment of the present disclosure may have an embossed and punched surface structure, as illustrated in FIG. 2C, and may be used as a negative electrode material of a zinc-ion capacitor, as illustrated in FIG. 2D.

By the method of manufacturing the negative electrode material for the zinc-ion capacitor according to an embodiment of the present disclosure, a negative electrode material for a zinc-ion capacitor, which has an embossed and punched surface structure with an enhanced ion diffusion capability and wettability, may be manufactured.

A zinc-ion capacitor according to another embodiment of the present disclosure includes the negative electrode material for the zinc-ion capacitor according to an embodiment of the present disclosure, or a negative electrode material for a zinc-ion capacitor manufactured by the method of manufacturing the negative electrode material for the zinc-ion capacitor according to another embodiment of the present disclosure; a positive electrode material including a carbon material; and an aqueous electrolyte filled between the negative electrode material and the positive electrode material.

In an embodiment, the carbon material may include at least one selected from a group consisting of activated carbon, acetylene black, furnace black, carbon black, Ketjen black, Super-P, graphene, and graphite.

Desirably, the carbon material may be activated carbon.

In an embodiment, the aqueous electrolyte may include at least one selected from a group consisting of zinc sulfate (ZnSO₄), zinc chloride (ZnCl₂), zinc bromide (ZnBr₂), zinc acetate (Zn(O₂CCH₃)₂), and zinc nitrate (Zn(NO₃)₂) of 0.5 M to 3 M; 0.5 M to 2.5 M; 0.5 M to 2 M; 0.5 M to 1.5 M; 0.5 M to 1 M; 1 M to 3 M; 1 M to 2.5 M; 1 M to 2 M; 1 M to 1.5 M; 1.5 M to 3 M; 1.5 M to 2.5 M; 1.5 M to 2 M; 2 M to 3 M; 2 M to 2.5 M; or 2.5 M to 3 M.

Desirably, zinc sulfate exhibits the most excellent performance. It may be inferred from the fact that zinc sulfate contains a sulfate anion that is most preferred in an electrodeposition process of zinc.

The zinc sulfate (ZnSO₄) has a conductivity at room temperature of about 50 mS/cm, which is less than that of an alkaline electrolyte (>400 mS/cm), and an advantage of having an extremely high reversibility of electrochemical oxidation/reduction reactions.

Desirably, the aqueous electrolyte may be zinc sulfate (ZnSO₄) of 1.5 M to 2.5 M. In an embodiment, the zinc-ion capacitor may have an energy density of 50 W h kg⁻¹ to 200 W h kg⁻¹ at 450 W kg⁻¹ to 9,000 W kg⁻¹.

In an embodiment, the zinc-ion capacitor may have a specific capacity of 70 mAh g⁻¹ to 150 mAh g⁻¹ at a current density of 10.0 A g⁻¹. As an embossed and punched surface structure of a zinc negative electrode material is controlled, an increase in capacitance may be caused by an increase in an electrochemical reaction area.

In an embodiment, the zinc-ion capacitor may have a capacitance retention of 90% or greater after “10,000” cycles at the current density of 10.0 A g⁻¹. An embossed and punched structure of a negative electrode material may exhibit an excellent capacitance retention at a high charge/discharge rate by reducing a zinc-ion diffusion distance within an electrolyte at a current density of a high rate. An excellent lifespan maintenance characteristic is due to an excellent reversibility of the zinc-ion capacitor.

Since a zinc-ion negative electrode material with a controlled surface structure is included in the zinc-ion capacitor according to an embodiment of the present disclosure, a zinc-ion diffusion capability may be enhanced. Thus, the electrochemical reaction area may increase to enhance energy storage performance and lifetime stability.

Hereinafter, the present disclosure is described in more detail based on examples and comparative examples.

However, the following examples are only for illustrating the present disclosure, and description of the present disclosure is not limited to the following examples.

Zinc (Zn)-ion hybrid capacitors (ZICs) have been considered as the next-generation energy storage technology due to their high energy densities and excellent safety. However, ZICs still have serious challenges in overcoming poor rate performance and low long-term stability at a high current density related to inefficient use of an interface between a Zn negative electrode material and an electrolyte, along with a poor wettability of an electrode, which lead to a growth of uniform Zn dendrites on a surface of a negative electrode material. To address the above drawbacks, an advanced surface-engineering approach, involving a uniform, embossed, and punched structure of a negative electrode material, is presented herein. A fabricated ZIC provides excellent stability, with improved energy densities of 108 W h kg⁻¹ and 69 W h kg⁻¹ at 450 W kg⁻¹ and 9,000 W kg⁻¹, and with a capacity retention of 90% during “10,000” cycles at 10.0 A g⁻¹. The above findings suggest that advanced surface engineering is an influential tool for the next-generation ZICs.

### Experiment

FIG. 2 is a diagram schematically illustrating a method of manufacturing a negative electrode material for a zinc-ion capacitor according to an embodiment of the present disclosure.

As schematically illustrated in FIG. 2, an embossed and punched Zn foil (EPZN) for ZIC negative electrode materials was simply fabricated via roll pressing with a stainless-steel mesh. A Zn foil with a thickness of 25 μm was used as an active material and a current collector. A bare Zn foil (FIG. 2A) overlapped a steel use stainless (SUS) mesh with a thickness of 300 μm. A spacing of presses was set to 50 μm, then the overlapped foil was passed into a roll press to generate an embossed and punched structure (FIG. 2B). Simultaneously, furrows and macropores were formed in the EPZN as the Zn foil was pressed by the SUS mesh (FIG. 2C). For comparison, embossed Zn foil (EZN) samples were also prepared using a wider press spacing of 100 μm. Finally, a ZIC was fabricated using the obtained EPZN as an anode, an aqueous electrolyte, and activated carbon as a positive electrode material (FIG. 2D).

Surface morphologies of the bare Zn, the EZN, and the EPZN were investigated via a scanning electron microscopy (SEM) and a three-dimensional surface confocal laser scanning microscopy (3D SCLSM). The crystalline nature and chemical bonding states of three samples were explored via an X-ray diffraction (XRD) and an X-ray photoelectron spectroscopy (XPS). A porosimetry of each of the samples was measured using a permeability tester, and a wettability was investigated via a measurement of a contact angle. Energy storage performance of each of the samples was tested using a two-electrode system including a prepared foil as a negative electrode material, activated carbon as a positive electrode material, and 2 M zinc sulfate (ZnSO₄) as an electrolyte.

A positive electrode material was prepared by coating the current collector with a slurry of activated carbon as an active material, polyvinylidene difluoride as a binder, and Ketien Black as a conductive material mixed in N-Methyl 2-pyrrolidine.

Subsequently, an electrochemical impedance spectroscopy (EIS) was performed by applying an AC signal of 5 mV in a frequency range of 10⁵ to 10⁻² Hz. An electrochemical reaction was examined using a cyclic voltammetry (CV) curve at a scan rate of 10 mV s⁻¹. To investigate a galvanostatic Zn plating/stripping behavior, two Zn negative electrode materials (Zn|Zn cells) were used with current densities of 0.5 mA cm⁻² and 2.0 mA cm⁻² for 30 hours and 70 hours, respectively. Rate performances of ZICs were evaluated at current densities of 0.5 A g⁻¹ to 10.0 A g⁻¹. A cycling stability was tested at current densities of 1.0 A g⁻¹ and 10.0 A g⁻¹ for “3,000” and “7,000” cycles, respectively.

### Results and Discussion

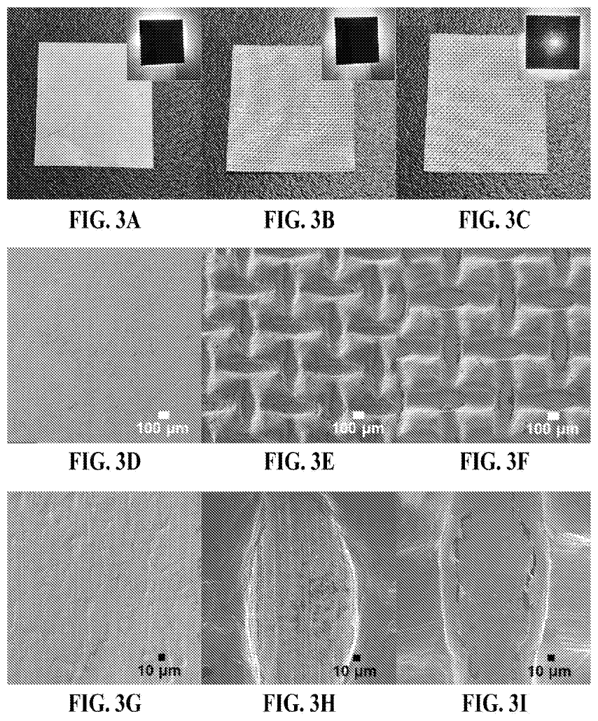

FIG. 3 illustrates a morphological characterization of a zinc negative electrode material: FIGS. 3A to 3C illustrate photographic images with inset images obtained under illumination from below, FIGS. 3D to 3F illustrate low-magnification images, and FIGS. 3G to 3I illustrate high-magnification scanning electron microscopy (SEM) images of bare Zn (FIGS. 3A, 3D, and 3G), an embossed Zn negative electrode material (EZN; FIGS. 3B, 3E, and 3H), and an embossed and punched Zn negative electrode material (EPZN; FIGS. 3C, 3F, and 3I), according to an embodiment of the present disclosure.

Referring to FIG. 3, the bare Zn exhibits a flat surface (FIG. 3A), whereas both the EZN (FIG. 3B) and EPZN (FIG. 3C) exhibit a distinct embossed structure. In addition, when foils were illuminated from below, inset images clearly indicate that the EPZN easily transmits light, whereas the bare Zn and the EZN do not. Morphologies of the bare Zn, the EZN, and the EPZN are further revealed by the SEM images in FIGS. 3D to 3I.

The bare Zn exhibits a smooth surface (FIGS. 3D and 3G), whereas the EZN (FIGS. 3E and 3H) and the EPZN (FIGS. 3F and 3I) exhibit embossed structures with 200 μm-500 μm furrows. In addition, the EPZN exhibits the punched structure with macropores. Thus, a press spacing is important to generate an embossed and punched structure of a Zn electrode. As the press spacing decreases, the embossed structure becomes clearer. The above results prove the generation of the embossed and punched structure, which may potentially provide an efficient ion diffusion pathway, leading to enhanced rate performance of a ZIC.

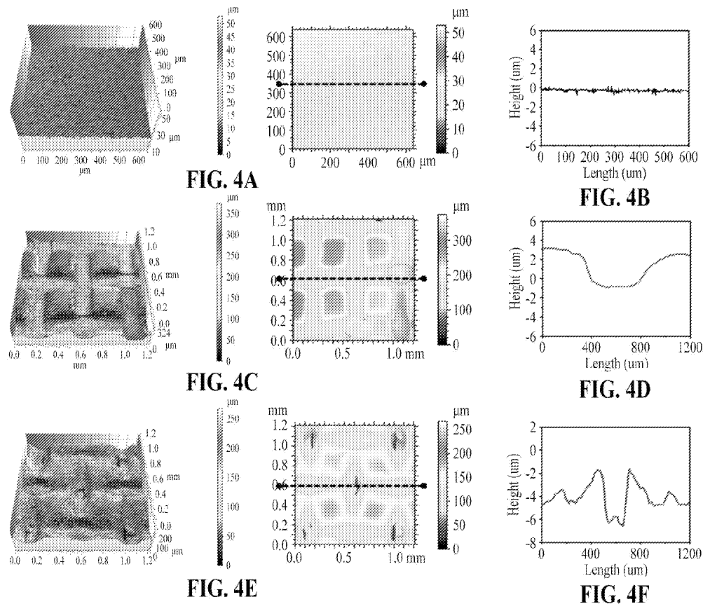

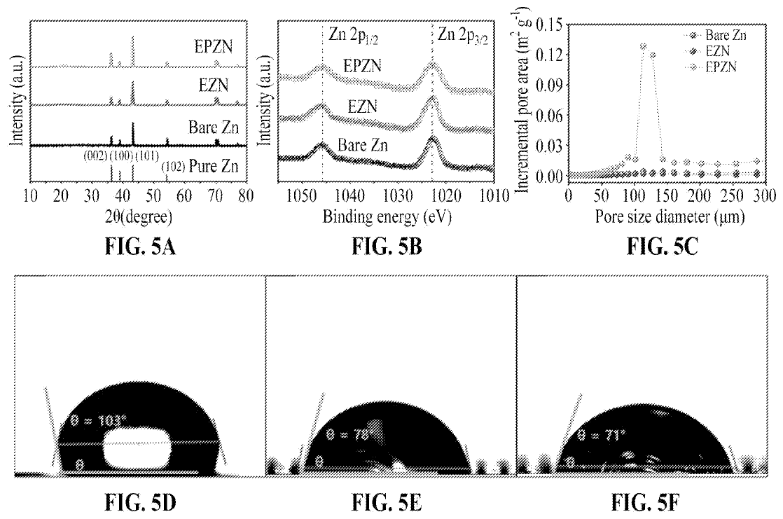

FIGS. 4A, 4C, and 4E illustrate three-dimensional surface confocal laser III scanning microscopy (3D SCLSM) images and FIGS. 4B, 4D, and 4F illustrate corresponding height plots of a bare Zn electrode (FIGS. 4A and 4B), an EZN electrode (FIGS. 4C and 4D), and an EPZN electrode (FIGS. 4E and 4F), according to an embodiment of the present disclosure.

Surface properties of the bare Zn, the EZN, and the EPZN were further revealed by the 3D SCLSM of FIG. 4. Here, the line profiles clearly reflect a smooth and flat surface of the bare Zn (FIGS. 4A and 4B), and distinct rising-and-falling embossed structures of the EZN (FIGS. 4C and 4D), with furrow depths of ˜4 μm. In addition, a punched structure of the EPZN is clearly observed, with a depth of ˜9 μm (FIGS. 4E and 4F). Based on the above result, it is confirmed that a punched structure was successfully generated by applying a high pressure to overlapping mesh portions.

FIGS. 5A to 5C illustrate a structural characterization of a Zn negative electrode material via an XRD (FIG. 5A), Zn 2p XPS (FIG. 5B), and a measurement of a porosimetry (FIG. 5C), and FIGS. 5D to 5F illustrate measurements of contact angles of a bare Zn electrode (FIG. 5D), an EZN electrode (FIG. 5E), and an EPZN electrode (FIG. 5F), according to an embodiment of the present disclosure.

Crystal structures of the bare Zn, the EZN, and the EPZN are revealed by XRD results in FIG. 5A. Here, all foils exhibit diffraction peaks at approximately 36.2°, 38.9°, and 43.2°, corresponding to (002), (100), and (101) planes of Zn, respectively.

In addition, chemical bonding states on foil surfaces are indicated by XPS results in FIG. 5B. Thus, Zn 2p XPS spectra of each sample exhibit two peaks at ˜1021.6 eV and ˜1044.6 eV, with a spin energy separation of 23.0 eV, corresponding to the Zn 2p_{3/2} and Zn 2p_{1/2} of a Zn phase, respectively. The above results further demonstrate successful surface engineering of the Zn foil with a generation of an embossed and punched structure and without any changes in the crystal structures and surface chemical bonding states.

Porous structures of the bare Zn, the EZN, and the EPZN are revealed by mercury-penetration porosimetry results in FIG. 5C. Here, the EPZN exhibits a significantly enhanced pore area in a size range of 100 μm to 150 μm, which signifies a presence of macropores (pore widths >75 μm) in agreement with the above-mentioned SEM results. A macropore structure of the EPZN is expected to increase the number of electrochemical sites and improve an ion diffusion capability, thereby enhancing electrochemical performance of a ZIC.

Wetting behaviors of the bare Zn, the EZN, and the EPZN are demonstrated by contact angle results in FIGS. 5D to 5F, respectively. Here, the EPZN shows the lowest contact angle of 71° (FIG. 5F) due to the embossed and punched structure, while the bare Zn exhibits the highest contact angle of 103° (FIG. 5D) due to a flat and smooth surface. Thus, an enhanced wettability of the EPZN due to the surface engineering process is expected to improve rate performance and long cycling stability of the ZIC via an efficient operation of an electrode-electrolyte interface.

Various ZICs were fabricated using the bare Zn, the EZN, or the EPZN as a negative electrode material, using 2M ZnSO₄ as an electrolyte, and using activated carbon as a positive electrode material.

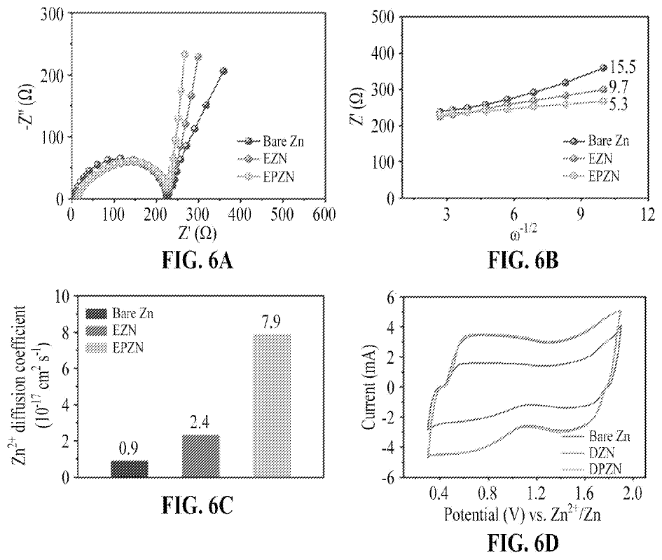

FIG. 6 illustrates results of an electrochemical kinetics analysis of a bare Zn electrode, an EZN electrode, and an EPZN electrode, according to an embodiment of the present disclosure.

Referring to FIG. 6, the electrochemical kinetics of various electrodes is proved by EIS and CV results. Here, EIS Nyquist plots (FIG. 6A) of all the three electrodes exhibit a semi-circle in a high-frequency region and a straight sloping line in a low-frequency region, which express a charge-transfer resistance and Warburg impedance, respectively. Charge-transfer resistances of the EZN electrode and the EPZN electrode are seen to be similar to that of the bare Zn, which indicates that surface engineering does not alter electrical characteristics. The EZN electrode and the EPZN electrode exhibit significantly lower Warburg impedances than that of the bare Zn, which suggests an improved ion diffusion capability due to the surface-engineering process.

A Zn-ion diffusion coefficient D was obtained using [Equation 1] and [Equation 2].

$${Z}_{real} = {R}_{e} + {R}_{e t} + {σ}_{w} {ω}^{- \frac{1}{2}} \qquad [ Equation 1 ]$$

$$D = {R}^{2} {T}^{2} / 2 {A}^{2} {n}^{4} {F}^{4} {C}^{2} {σ}_{w}^{2} \qquad [ Equation 2 ]$$

Here, Re is a bulk resistance, D is an ion diffusion coefficient, R is a gas constant, T is a temperature, A is an area of an electrode, n is the electron number per molecule, F is a Faraday constant, and C is an ion molar concentration. From a correlation between Zᵣₑₐₗ and ω^{-1/2}, σ_{w} values of the bare Zn electrode, the EZN electrode, and the EPZN electrode were calculated as 5.3Ω cm² s^{-1/2}, 9.7Ω cm² s^{-1/2}, and 15.5Ω cm² s^{-1/2}, respectively, as illustrated in FIG. 6B. In addition, diffusion coefficients of Zn-ions were calculated to be 0.9×10⁻¹⁷ cm² s⁻¹, 2.4×10⁻¹⁷ cm² s⁻¹, and 7.9×10⁻¹⁷ cm² s⁻¹, respectively, as illustrated in FIG. 6C. Such improved EIS results for the EPZN electrode are attributed to a favorable diffusion capability of a Zn-ion due to an efficient use of an interface between a current collector and an electrode material provided by an embossed and punched structure. Thus, the EPZN electrode is anticipated to provide an outstanding energy-storage performance. CV curves of the bare Zn electrode, the EZN electrode, and the EPZN electrode obtained at 10 mV s⁻¹ in 0.2 V-1.8 V are illustrated in FIG. 6D, where Faradic plating/stripping of Zn ions on a surface (Zn↔2e⁻+Zn²⁺) of a negative electrode material is suggested by a presence of redox humps, thus demonstrating a characteristic ZIC behavior.

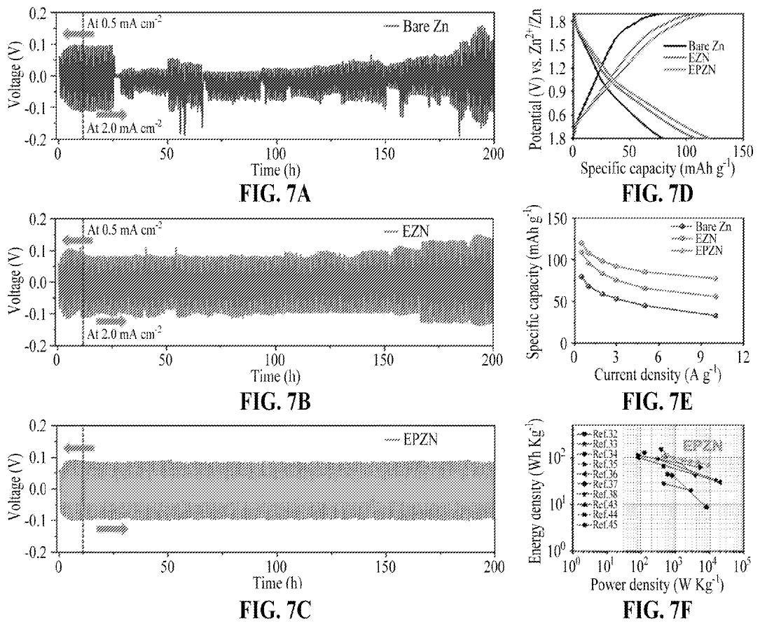

FIG. 7 illustrates electrochemical performance results of a ZIC fabricated using a bare Zn electrode, an EZN electrode, and an EPZN electrode, according to an embodiment of the present disclosure.

A low voltage hysteresis and cycling stability of a Zn anode are further demonstrated by results of galvanostatic plating/stripping measurements of symmetric Zn∥Zn cells (FIGS. 7A to 7C). Thus, voltage profiles as a function of time were obtained at 0.5 mA cm⁻² and 2.0 mAh cm⁻² for 10 hours and 190 hours, respectively. At a low current density of 0.5 mA cm⁻², each cell exhibits a stable and low voltage polarization during cycling. This is caused by a controllable growth of Zn dendrites on a surface of a negative electrode material. However, at a higher current density of 2.0 mA cm⁻², the bare Zn electrode exhibits a short circuit, as indicated by a sudden increase and decrease in voltage.

By contrast, the EZN electrode and the EPZN electrode continue to exhibit very stable voltage profiles. In particular, an embossed and punched structure provides the EPZN electrode with a more stable voltage profile than that of the EZN electrode, with average overpotentials of about 15 mV and 30 mV, respectively, during 200 hours of cycling. In addition, a structure and morphology of the EZN electrode were well retained after voltage profile tests, which signifies that the embossed and punched structure is favorable for plating/stripping of Zn ions. Furthermore, all the electrodes showed by-products on surfaces. An improved ion diffusion capability and wettability on a stable surface of the EPZN electrode free of dendrites is expected to contribute to an excellent kinetic behavior, thus resulting in outstanding rate performance of ZICs.

Charge-discharge curves of the bare Zn electrode, the EZN electrode, and the EPZN electrode obtained at 0.5 A g⁻¹ in a voltage range of 0.3 V to 1.8 V are illustrated in FIG. 7D, and indicate closely similar charging and discharging capacities for all three electrodes. In addition, rate performance of fabricated ZICs is illustrated in FIG. 7E, where the EPZN electrode exhibits significant specific capacities of 120 mAh g⁻¹, 107 mAh g⁻¹, 98 mAh g⁻¹, 92 mAh g⁻¹, 85 mAh g⁻¹, and 77 mAh g⁻¹ at current densities of 0.5 A g⁻¹, 1.0 A g⁻¹, 2.0 A g⁻¹, 3.0 A g⁻¹, 5.0 A g⁻¹, and 10.0 A g⁻¹, respectively. Rate performance of this device is even more remarkable when compared with those of the bare Zn electrode and the EZN electrode. An increased specific capacity of the EPZN electrode is due to an enhanced ion diffusion ability via a shorter ion pathway provided by an engineered surface with the embossed and punched structure.

Moreover, power and energy densities of the EPZN electrode are illustrated in FIG. 7F. Here, the above device exhibits energy densities of 108 W h kg⁻¹ and 69 W h kg⁻¹ at 450 W kg⁻¹ and 9,000 W kg⁻¹, respectively, which are considerably greater than those of previously reported supercapacitors.

To further investigate the Zn plating behavior of the negative electrode material, SEM images of the bare Zn electrode, the EZN electrode, and the EPZN electrode were obtained after a charging process at a high current density of 10.0 A g⁻¹.

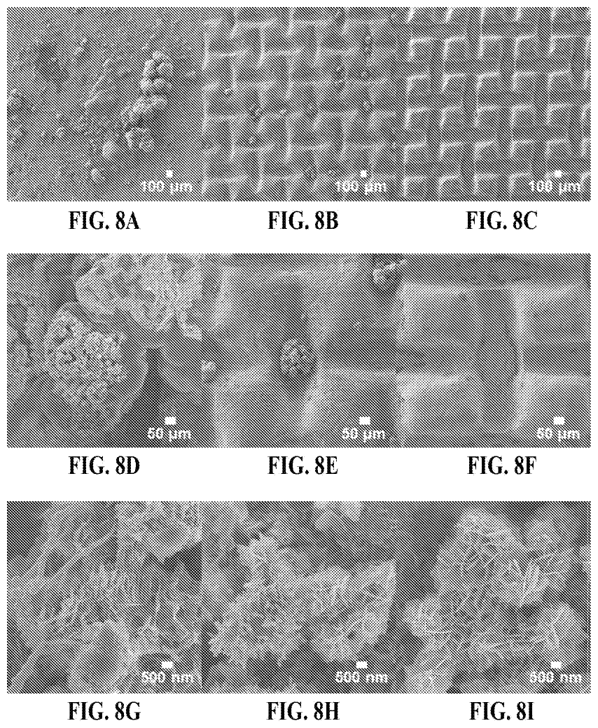

FIG. 8 illustrates SEM images of a bare Zn electrode (FIGS. 8A, 8D, and 8G), an EZN electrode (FIGS. 8B, 8E, and 8H), and an EPZN electrode (FIGS. 8C, 8F, and 8I) obtained after a charging process at a high current density of 10.0 A g⁻¹, according to an embodiment of the present disclosure.

Referring to FIG. 8, the bare Zn electrode (FIGS. 8A, 8D, and 8G) exhibits a rough surface with rugged sites, which implies inefficient utilization of an interface between a negative electrode material and an electrolyte. Due to an irregular growth of a Zn dendrite on a surface of an electrode, energy storage performance is reduced by a low reversibility. By contrast, the EZN electrode (FIGS. 8B, 8E, and 8H) exhibits a relatively uniform surface sparsely coated with agglomerated Zn dendrites on furrows. In addition, the EPZN (FIGS. 8C, 8F, and 8I) exhibits uniform plating of Zn onto a surface of an electrode. The above uniform plating of Zn is regulated by an embossed and punched structure and is likely responsible for a synergistic effect of an improved ion diffusion capability and an enhanced wettability. Thus, an engineered surface of a negative electrode material may function as an effective ionic sieve to facilitate a uniform distribution of intense Zn ionic flux.

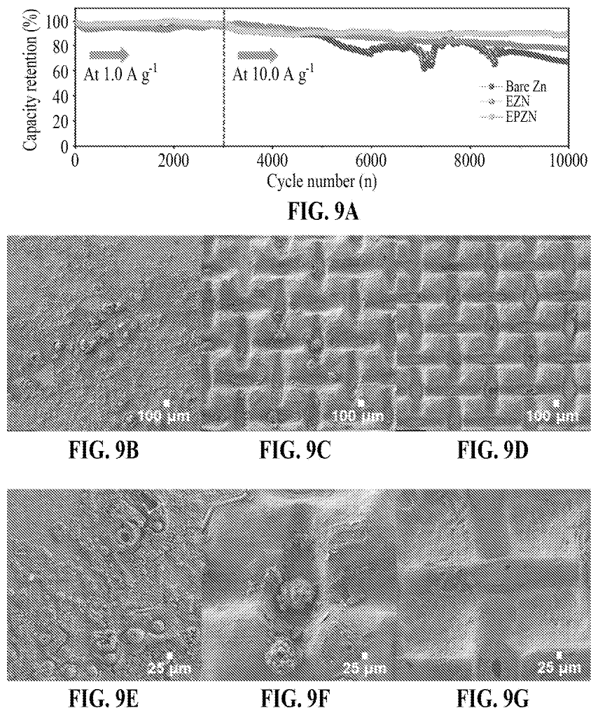

FIG. 9A illustrates cyclic stabilities of a bare Zn electrode, an EZN electrode, and an EPZN electrode for up to “10,000” cycles at a high current density of 10.0 A g⁻¹, and FIGS. 9B to 9G illustrate SEM images of the bare Zn electrode (FIGS. 9B and 9E), the EZN electrode (FIGS. 9C and 9F), and the EPZN electrode (FIGS. 9D and 9G) after a cycling test at the high current density of 10.0 A g⁻¹, according to an embodiment of the present disclosure.

Long cycling stabilities of prepared electrodes are compared during “3,000” and “10,000” cycles at current densities of 1.0 A g⁻¹ and 10.0 A g⁻¹ in FIG. 9A. After a low-rate cycling test, all the electrodes exhibit excellent capacity retentions of ˜99%. During a high-rate cycling test, however, the bare Zn electrode exhibits unstable performance due to a shorter ionic diffusion time for Zn plating. Nevertheless, the EPZN electrode exhibits a superior capacity retention of 90%, in comparison to 67% for the bare Zn electrode and 77% for the EZN electrode. After “10,000” cycles at a current density of 10.0 A g⁻¹, the bare Zn electrode, the EZN electrode, and the EPZN electrode exhibit specific capacities of 23 mAh g⁻¹, 45 mAh g⁻¹, and 71 mAh g⁻¹.

The above result is attributed to an enhanced wettability of the EPZN electrode, which facilitates ion transfer across an electrode/electrolyte interface. The SEM images of the bare Zn electrode, the EZN electrode, and the EPZN electrode obtained after the “10,000” cycles are illustrated in FIGS. 9D to 9G. Here, the bare Zn electrode (FIGS. 9B and 9E) and the EZN electrode (FIGS. 9C and 9F) exhibit residuary Zn dendrites on their surfaces, which implies an irreversible reaction. By contrast, the surface of the EPZN electrode (FIGS. 9D and 9G) is similar to its initial state, thus demonstrating that the surface-engineered, embossed and punched structure may outfit a stable interface between the electrode and an electrolyte during the high-rate cycling test.

In summary, successful surface engineering of a negative electrode material for ZICs was demonstrated in embodiments of the present disclosure.

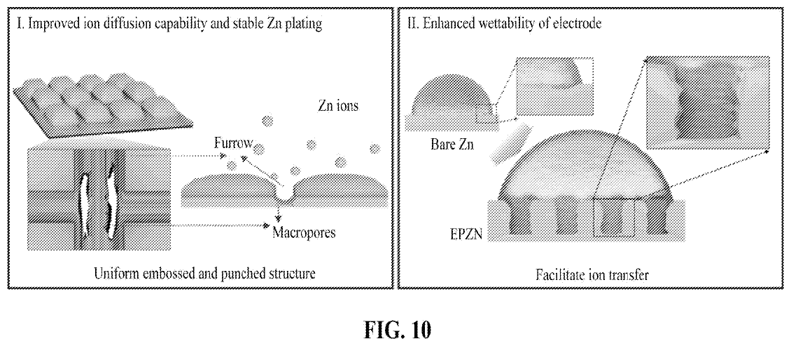

FIG. 10 is a diagram schematically illustrating advantages of an EPZN electrode, including an improved ion diffusion capability and stable Zn plating, along with an enhanced electrode, according to an embodiment of the present disclosure.

As schematically illustrated in FIG. 10, a uniform embossed and punched structure provides an improved ion diffusion capability due to an enhanced pore area in a size range of 100 μm to 150 μm and stable Zn plating on a surface of an electrode, to evaluate a specific capacity and rate performance. In addition, an improved wettability by the surface engineering with an embossed structure enabled the effective utilization of an electrode/electrolyte interface, which led to a fast long-term stability.

### CONCLUSIONS

In an embodiment of the present disclosure, an embossed and punched Zn foil (EPZN) electrode with a controlled surface structure was prepared as a stable negative electrode material for high-rate performance zinc-ion hybrid capacitors (ZICs). The energy storage performance of the EPZN electrode was confirmed, as well as synergistic effects of the enhanced ion diffusion and improved wettability of the electrode. As a result, the EPZN electrode provided excellent rate performance of 77 mA h g⁻¹, remarkable energy storage performance, and a cycling stability of 90% for “10,000” cycles at a current density of 10.0 A g⁻¹, along with a remarkable specific capacity of 120 mA h g⁻¹ at 0.5 A g⁻¹, and excellent high energy storage performance. The improved rate performance is due to an improved ion diffusion capability and stability provided by the uniform embossed and punched structure, and the excellent cycling stability is due to an enhanced wettability of a negative electrode material owing to the efficient utilization of the electrode/electrolyte interface. Thus, an embodiment of the present disclosure demonstrated that due to the use of the surface engineering to fabricate an embossed and punched structure, an interesting pathway for the advanced design of a negative electrode material for ZICs may be provided.

While the embodiments are described, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

1. A negative electrode material for a zinc-ion capacitor, comprising:
embossed and punched zinc (Zn),
wherein the embossed zinc comprises a plurality of irregularities having cross sections with a convex shape, a concave shape, or both the shapes, and
wherein the punched zinc comprises macropores formed therein,

2. The negative electrode material for the zinc-ion capacitor of claim 1, wherein the embossed zinc has a pattern with at least one shape selected from a group consisting of a triangle, a square, a pentagon, a hexagon, an octagon, a sphere, a hemisphere, a circle, and an oval.

3. The negative electrode material for the zinc-ion capacitor of claim 2, wherein
the pattern has a spacing of 30 μm to 200 μm, and
the pattern has a furrow with a depth of 100 μm to 600 μm.

4. The negative electrode material for the zinc-ion capacitor of claim 1, wherein the macropores have a width of 50 μm to 200 μm.

5. The negative electrode material for the zinc-ion capacitor of claim 1, wherein a water contact angle on a surface of the negative electrode material for the zinc-ion capacitor ranges from 50° to 100°.

6. A method of manufacturing a negative electrode material for a zinc-ion capacitor, comprising:
a step of preparing a zinc (Zn) foil; and
a step of performing roll pressing such that a surface of the zinc (Zn) foil is embossed and punched, by disposing the metal mesh on the zinc (Zn) foil.

7. The method of manufacturing the negative electrode material for the zinc-ion capacitor of claim 6, wherein the step of performing of the roll pressing comprises passing the metal mesh on the zinc (Zn) foil between a first roller and a second roller, which face each other, performing roll pressing with the first roller and the second roller at a pressure of 100 psi to 2,000 psi, a temperature of 20° C. to 100° C., and a movement speed of 0.01 m/min to 1 m/min, and forming an embossed and punched structure on the zinc (Zn) foil.

8. The method of manufacturing the negative electrode material for the zinc-ion capacitor of claim 6, wherein the metal mesh has a pattern with at least one shape selected from a group consisting of steel use stainless (SUS), a vinyl-coated material (VCM) steel plate, galvanized steel material (hot-dipped galvanized iron (GI) sheet), an electronic galvanized iron (EGI) sheet, a hot-rolled, hot-dipped galvanized iron (HGI) sheet, a pre-coated metal (PCM) steel plate, and aluminum (Al).

9. The method of manufacturing the negative electrode material for the zinc-ion capacitor of claim 6, wherein the metal mesh has a pattern with at least one shape selected from a group consisting of a triangle, a square, a pentagon, a hexagon, an octagon, a sphere, a hemisphere, a circle, and an oval.

10. The method of manufacturing the negative electrode material for the zinc-ion capacitor of claim 9, wherein
the pattern of the metal mesh has a spacing of 30 μm to 200 μm, and
the metal mesh has a thickness of 100 μm to 600 μm.

11. A zinc-ion capacitor comprising:
the negative electrode material for the zinc-ion capacitor of claim 1;
a positive electrode material comprising a carbon material; and
an aqueous electrolyte filled between the negative electrode material and the positive electrode material.

12. The zinc-ion capacitor of claim 11, wherein
the carbon material comprises at least one selected from a group consisting of activated carbon, acetylene black, furnace black, carbon black, Ketjen black, Super-P, graphene, and graphite, and
the aqueous electrolyte comprises at least one selected from a group consisting of zinc sulfate (ZnSO₄), zinc chloride (ZnCl₂), zinc bromide (ZnBr₂), zinc acetate (Zn(O₂CCH₃)₂), and zinc nitrate (Zn(NO₃)₂) of 0.5 M to 3 M.

13. The zinc-ion capacitor of claim 11, wherein the zinc-ion capacitor has an energy density of 50 W h kg⁻¹ to 200 W h kg⁻¹ at 450 W kg⁻¹ to 9,000 W kg⁻¹.

14. The zinc-ion capacitor of claim 11, wherein the zinc-ion capacitor has a specific capacity of 70 mAh g⁻¹ to 150 mAh g⁻¹ at a current density of 10.0 A g⁻¹.

15. The zinc-ion capacitor of claim 11, wherein the zinc-ion capacitor has a capacitance retention of 90% or greater after “10,000” cycles at a current density of 10.0 A g⁻¹.
